(19) United States
(12) Patent Application Publication
(10) Pub. No.: US 2014/0164176 A1
(43) Pub. Date: Jun. 12, 2014

(54) FAST-CHECKOUT USING SMART CART

(71) Applicant: RAWLLIN INTERNATIONAL INC., Tortola (VG)

(72) Inventor: Vladimir V. Kitlyar, Sankt-Petersburg (RU)

(73) Assignee: RAWLLIN INTERNATIONAL INC., Tortola (VG)

(21) Appl. No.: 13/710,957

(22) Filed: Dec. 11, 2012

(51) Int. Cl. G06Q 30/06

(52) U.S. Cl. CPC G06Q 30/0633
USPC 705/26.8; 235/383

(57) ABSTRACT

Systems and methods disclosed herein relate to fast checkout using a smart cart. A forward facing radio frequency identification (“RFID”) reader component can read a first set of RFID tags and generate a first set of items based on RFID information read from the first set of RFID tags. A rear facing RFID reader component can read a second set of RFID tags and generate a second set of items based on RFID information read from the second set of RFID tags. A shopping cart list component can and remove items to a set of shopping cart items based on updates received from the forward facing RFID reader component and the rear facing RFID reader component regarding the first set of items and the second sets of items.

### TECHNICAL FIELD

This application relates to shopping and more particularly to a fast track payment system to securely checkout and exit a store using a smart cart.

### BACKGROUND

The brick and mortar shopping experience had remained unchanged for many years. Customers selected items they wished to purchase. Customers either gathered the items themselves, or gathered product identifiers that they could then take to a cashier to pay for. After paying for the products at the cashier, customers were free to leave the store with their products. One bottleneck in this traditional brick and mortar shopping experience is the check out process. Depending on the day of the week, the time of day, or the season, retail stores can vary in how busy they are. While appropriate staffing, e.g., additional cashiers available during busy times, can help alleviate the pressures that occur when a large amount of customers desire to check out in unison, additional cashiers cost money to employ, or are not always available.

A generally pleasant shopping experience for a customer while selecting products and adding them to their shopping cart can quickly change to a highly negative experience if the customer is forced to wait for an extended period of time to check out. Some customers may see long checkout lines and abandon the products they were planning on purchasing and leave the store without making a purchase. In the case of a customer that does wait in line for an extended period of time, they may not return to the store and may prefer to shop at a store carrying similar products but with less of wait, costing the original store potential future sales. In the case of a customer that abandons the cart, the store loses money in not conducting the sale, and may bear additional costs in restocking the items the customer abandoned to the proper place on their shelves.

With the advent of online shopping, consumers can choose to avoid the brick and mortar experience altogether and instead purchase a product online. In most cases, online customers do not have to wait in line to check out, and can purchase products on their own timeline. However, online shopping does carry inherent disadvantages. For example, a customer cannot physically see the product they are purchasing online and must rely on photos, videos, or a written description of the product. In addition, online shoppers most likely have to wait for the product to be packaged and shipped before receiving the product, while a brick and mortar shopper can take the product with them immediately.

While the traditional brick and mortar shopping experience has distinct advantages in seeing in the product, and catering to instant gratification in taking the product with you upon your exit of the store, processing brick and mortar transactions is traditionally far less convenient that processing an online transaction. Some stores have combated this problem by establishing self checkout lanes where customers can scan the products in their shopping cart, bag the products, and pay for the products. These self checkout lanes can be subject to the same inconveniences of the traditional cashier, in that lines can still form during busy shopping periods requiring customers to wait. For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to fast checkout at a retail store using a smart cart. A shopping cart device can have a forward facing radio frequency identification (“RFID”) reader component that can read a first set of RFID tags and generate a first set of items based on RFID information read from the first set of RFID tags. A rear facing RFID reader component can read a second set of RFID tags and generate a second set of items based on RFID information read from the second set of RFID tags. A shopping cart list component can and remove items to a set of shopping cart items based on updates received from the forward facing RFID reader component and the rear facing RFID reader component regarding the first set of items and the second sets of items. A communications component can send and receive data respectively to or from a secure shopping system. A personalization component can receive identification data based on user input received by the shopping cart device, wherein the identification data includes payment vehicle data. A checkout component can, in response to receiving a checkout request, process the set of shopping cart list items to generate transaction data and send the transaction data to the secure shopping system. A payment processing component can present a transaction summary representing the transaction data to the user and requests a transaction authorization from the user. A shopping cart alarm component can trigger an alarm based on the transaction data, the first set of items, and the second set of items.

In another embodiment, a secure shopping system can comprise a communications component that is configured to send or receive data respectively to or from a shopping cart device. A payment information component can receive a payment profile from the shopping cart device, wherein the payment profile includes at least a payment account. A transaction component can receive transaction data representing transaction items from the shopping cart device wherein the transaction data includes radio frequency identification (“RFID”) tag data associated with the transaction items. A payment processing component can process a transaction based on the transaction data and the payment account.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates example flow diagram for implementing and using fast checkout using smart carts;

FIG. 2 illustrates example smart shopping carts;

FIG. 3 illustrates an example shopping cart device;

FIG. 4 illustrates an example shopping cart device including communications and personalization components;

FIG. 5 illustrates an example shopping cart device including checkout and payment processing components;

FIG. 6 illustrates an example shopping cart device including a shopping cart alarm component;

FIG. 7 illustrates an example flow diagram method for fast checkout using smart carts;

FIG. 8 illustrates an example flow diagram method for fast checkout using smart carts including exchanging data with a secure shopping system;

FIG. 9 illustrates an example flow diagram method for fast checkout using smart carts including transacting a transaction;

FIG. 10 illustrates an example flow diagram method for fast checkout using smart carts including triggering an alarm;

FIG. 11 illustrates an example secure shopping system;

FIG. 12 illustrates an example secure shopping system including a security checkout component;

FIG. 13 illustrates an example secure shopping system including a security checkpoint alarm component;

FIG. 14 illustrates an example secure shopping system including a security action component;

FIG. 15 illustrates an example block diagram of a computer operable to execute the disclosed architecture; and

FIG. 16 illustrates an example schematic block diagram for a computing environment in accordance with the subject specification.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

Systems and methods disclosed herein relate to fast checkout using a smart cart. A customer can use the smart shopping cart to deposit products into as they are shopping. Products can be affiliated with a radio frequency identification (“RFID”) tag that can be scanned by RFID readers embedded within the smart shopping cart. The shopping cart dynamically updates a list of products within the cart while the customer is shopping. The customer can then checkout using the smart shopping cart independent of the location of the cart, therefore, avoiding any line in the checkout process. In addition, the store can establish anti-theft protocols using the smart shopping cart that unobtrusively protect a store's interest in theft prevention, while offering a heightened level of convenience to the customer.

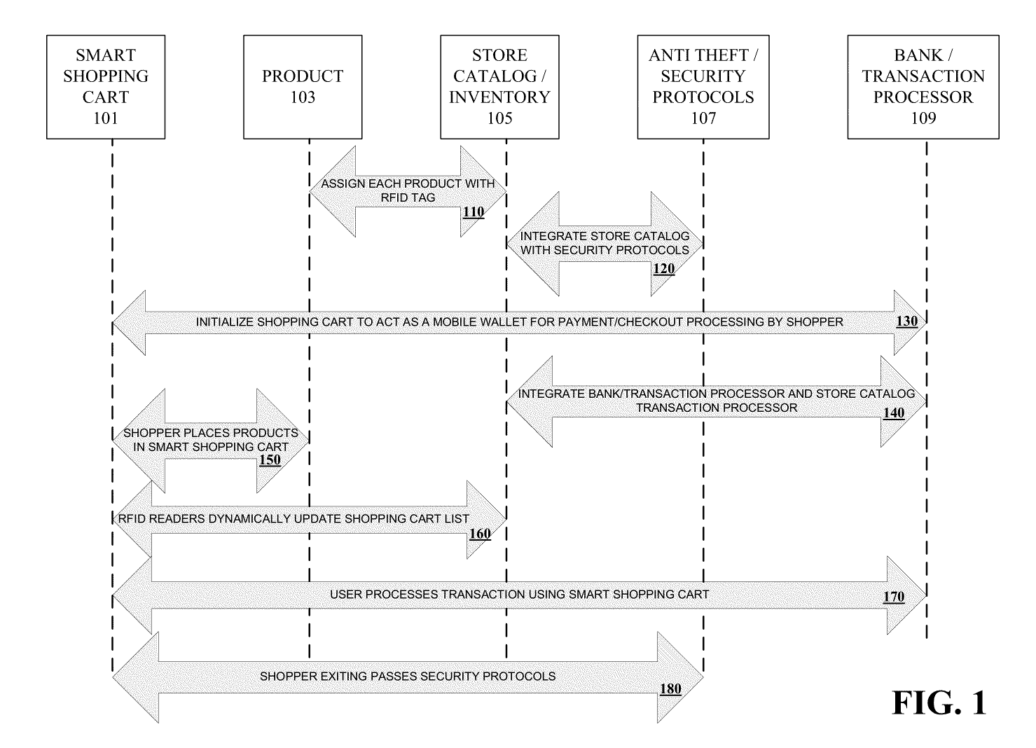

Referring now to FIG. 1 there is illustrated example flow diagram for implementing and using a fast checkout system using smart carts. The depicted steps illustrate exchanges of information that are both pre-requisite for implementing the system as well as steps in using the implemented fast checkout system. Steps 110 and 120 are perquisites for using the fast checkout system within a retail environment, as the products, store catalog, and security protocols are established to be later used by smart shopping cart 101.

Smart shopping cart 101 can be a proprietary device that includes the functionality as described herein or alternatively can be a proprietary device that works in conjunction with a consumer electronic device capable of communicating with the store.

At 110, each product 103 in a store catalog 105 can be assigned with a unique RFID tag. An attached RFID tag can be either short range or long range or a combination of both. In one implementation, each individual product, including those products that are identical, can be outfitted with a unique identification such that store catalog 105 can uniquely identity individual variations of each product. In another implementation, the unique identifier can be shared by identical products. By establishing a store catalog/inventory 105 of products correlated with a unique identifier, the catalog can later be used by, for example, anti theft/security protocols 107 in securely processing the transaction.

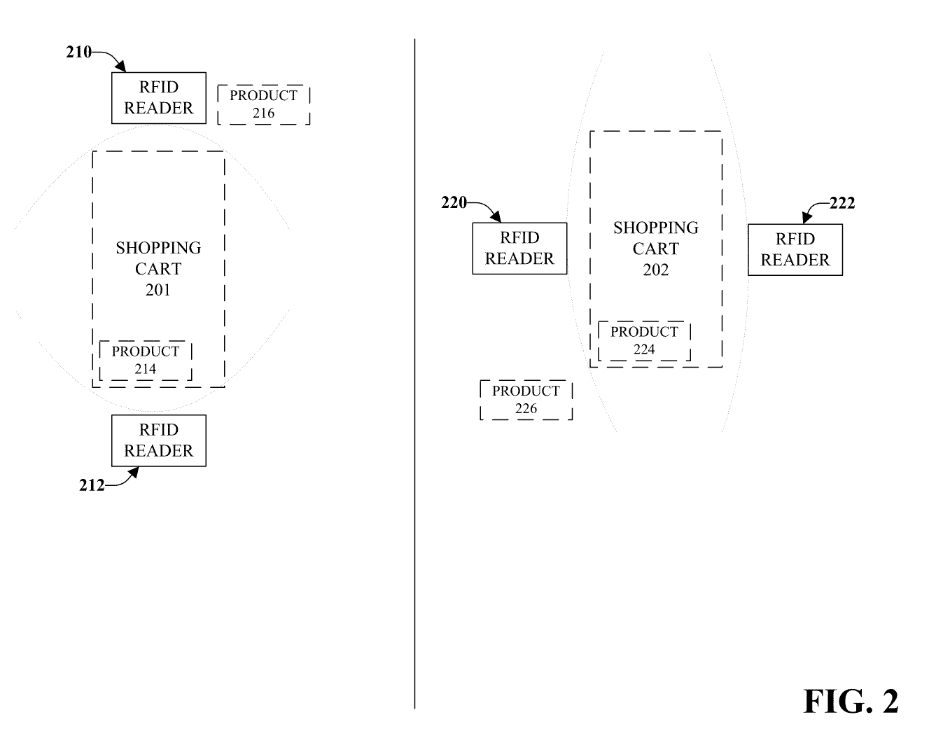

At 120, store catalog/inventory 105 can be integrated with anti theft security protocols 107. For example, an anti-theft gate or area can be established at the exits of the store. At the gate, a scanner or multiple scanners can be placed capable of reading both long range RFID tags and short range RFID tags. In addition, protocols can be established, as described in more detail with regards to FIG. 2, regarding the RFID scanners within the smart shopping cart. It can be appreciated that a static scanner established at a security gate can work in conjunction with the RFID readers within the smart shopping cart.

At 130, a consumer can begin the shopping process by initializing smart shopping cart 101 to act as a mobile wallet for payment/checkout processing by the shopper. For example, using bank/transaction processor 109, the shopper can be identified, and in one example given a purchase limit. A customer could sign into smart shopping cart 101 using a long, password, personal identification number (“PIN”), a thumb print, a fingerprint, facial recognition software, etc, where a shopper profile already exists with preferred payment instructions, such as a specific debit card, credit card, or checking account which the shopper wants to use to process the transaction. In another example, the smart shopping cart 101 can have a card reader on the device that can scan a physical card such as a debit card or a credit card. Bank 109 can then authorize prospective charges to the card, by, for example, placing a hold of funds on the account until a transaction is completed or abandoned. In one example, the shopper can authorize smart shopping cart 101 to place a specified amount on hold. It can be appreciated that a vendor can have some certainty that an amount placed on hold with credit or debit provider guarantees the funds are available later at checkout. A credit or charge limit can be established by the shopper, the bank or the retail store. Example of a credit or charge limit can include, a per transaction limit, a per day limit, a per week limit, a per month limit, etc. In addition, multiple shoppers can be affiliated with an identity, where limits are placed on individual shoppers or the group as a whole. For example, all members of a family can be affiliated with an account with common payment instructions; however, family members can have separate individual limits along with an overall family limit.

At 140, the bank/transaction processor 109 can be integrated with store catalog 105, such that the store catalog 105 can communicate transaction terms directly with bank/transaction processor and personal shopping device 101 can strictly communicate with the store. In this sense, access can be restricted to Bank/Transaction processor 109 to a single point of contact. It can be appreciated that in some instance, by limiting communications to a single point of contact, the security of transactions can be improved.

At 150, a shopper can begin selecting products they wish to purchase by placing them within smart shopping cart 101. RFID tag readers within the smart shopping cart 101 can detect products placed within the cart. It can be appreciated that communication at 160 can occur dynamically as products are placed into the cart at 150. In some implementations, as the product is selected, information about the product can be displayed on smart shopping cart 101, such as pricing, subtotals, quantity, additional product information, a link to a manufacturer web site, a product set of frequently asked questions (“FAQs”), etc. In another implementation, as products are removed from the cart, RFID scanners within the cart can detect the product is no longer present within the cart and a shopping cart list can be updated accordingly.

At 160, products selected at 150 can be moved to a shopping cart list. The shopping cart list can aggregate the unique product identifiers associated with each product added to the list for later use at a security checkpoint when the shopper is exiting the store. IN addition, as the shopping list is dynamically updated, the shopper can be informed via smart shopping cart 101 of the subtotal of items in the cart, or whether a specific product is actually on the shopping cart list. For example, a child could add or remove items from the shopping cart without a guardian's knowledge, and the guardian may wish to consult the shopping cart list to determine if a product in the shopping cart is actually on the shopping cart list.

At 170, the shopper using smart shopping cart 101 can process the transaction, using just smart shopping cart 101. For example, the payment terms authorized at step 130 can be used to complete the transaction by charging a debit card, credit card, withdrawing from a checking account, etc. The shopper using smart shopping cart 101 is not required to meet with an automated or non-automated cashier to close the transaction. Thus, the shopper can be anywhere within the store to close the transaction. This can save the shopper a significant amount of time as items are not needed to be rescanned, subtotaled, and paid for under the traditional retail experience. At this stage, a receipt can be generated. The receipt can be printed on the smart shopping cart, emailed to an email account associated with the shopper's identity, or saved and associated with the shopper's identity within the store.

At 180, a shopper exiting the store can pass through security protocols 107. The shopping cart, shopping bag, or the shopper themselves can be scanned to determine the products within the cart, bag, shopper. For example, security zones can be established at the store's exit where an RFID scanner can work individually or in tandem with the shopping cart RFID scanners to determine whether products within the shopping cart or on the person of the customers, in sum an exit list, have been paid for. The exit list is a list of the actual products the shopper is leaving the store with. The shopping cart list which was subtotaled and paid for at step 170 can then be compared to the exit list. If the two lists don't match, many different solutions can be implemented. For example, if the shopping cart list, e.g., the list of items the shopper paid for, does not include items in the exit list, the shopper can be immediately billed for the unpaid for items. Shoppers can agree to have their method of payment charged for any items not previously paid for, and can be notified of the additional charges. In another example, an alarm can be triggered that notifies store personnel of a potential theft. In an example where the shopper paid for items that are not in the exit list, the transaction can be modified to provide a credit to the shopper.

Referring now to FIG. 2, there are illustrated example smart shopping carts. Two similar implementations are depicted, shopping cart 201 and shopping cart 202. In shopping cart 201, RFID Reader 210 is placed at the opposite end of RFID reader 212. Both readers are pointed at each other. Thus, product 214 that is within shopping cart 201 will be read be by both RFID reader 210 and RFID reader 212. Product 216 which is near shopping cart 201 but outside the cart, will be read by RFID reader 212 but not by RFID reader 210. Thus, if both RFID readers read the same tag, the item can be added to a list reflecting the items within the cart.

Similarly, shopping cart 202 is flanked by RFID readers 220 and 222 respectively on opposite sides of shopping cart 202. Product 224 that is within shopping cart 202 will be read by both RFID readers 220 and 222. Product 226 that is outside the shopping cart will be read by only RFID reader 222. It can be appreciated that RFID readers can be setup on any side of a shopping cart, so long as both RFID readers are on opposite sides of the cart.

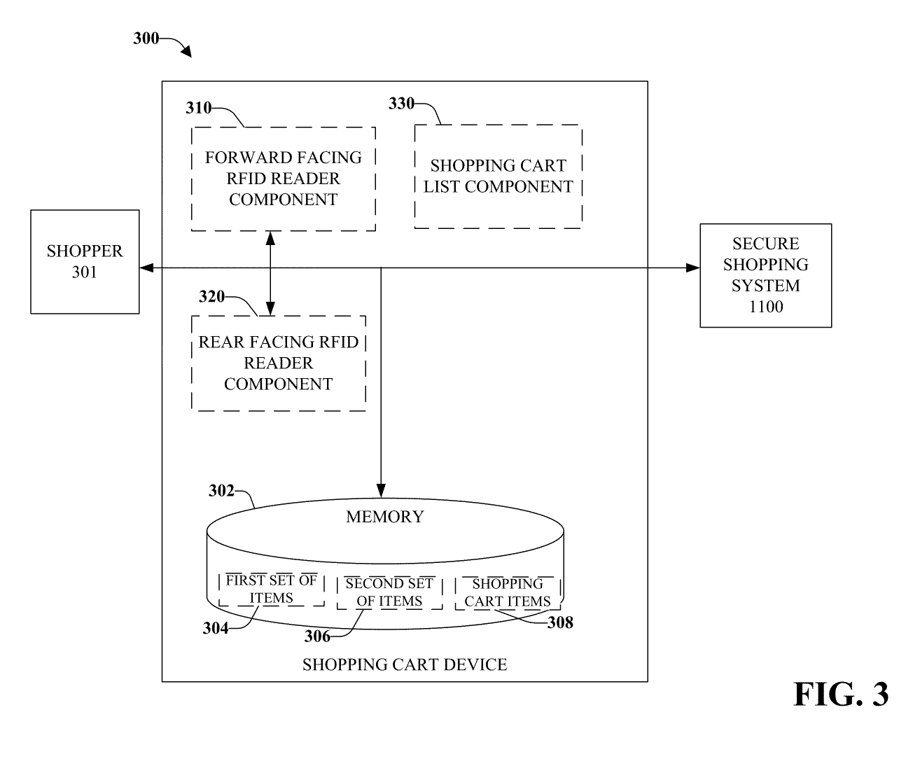

Referring now to FIG. 3, there is illustrated an example shopping cart device. Shopping cart device 300 can contain a forward facing RFID reader component 310, a rear facing RFID component 320, a shopping cart list component 330 and a memory 302, that share a common bus. Memory 302 can house a first set of items 304, a second set of items 306, and a set of shopping cart items 308 for use by other components. Forward facing RFID reader component 310 can read RFID a first set of RFID tags and generate a first set of items 304 based on RFID information read from the first set of RFID tags. Rear facing RFID reader component 320 can read a second set of RFID tags and generate a second set of items 306 based on RFID information read from the second set of RFID tags. In one implementation, the front facing RFID reader component and the rear facing RFID reader component are arranged to read RFID tags from opposite directions. In another implementation, the front facing RFID reader component and the rear facing RFID reader component are mechanically coupled to the shopping cart device.

Shopping cart list component 330 can add and remove items to a set of shopping cart items 308 based on updates received from the forward facing RFID reader component and the rear facing RFID reader component regarding the first set of items and the second sets of items. For example, as referenced supra with regards to FIG. 2, if an item is in both the first set of items and the second set of items, then the item can be determined to be in the shopping cart and be added to the set of shopping cart items 308. In another example, as items are removed the cart, e.g., one RFID reader can no longer read the RFID, the item can be determined to be removed from the shopping cart and can be removed from the set of shopping cart items 308.

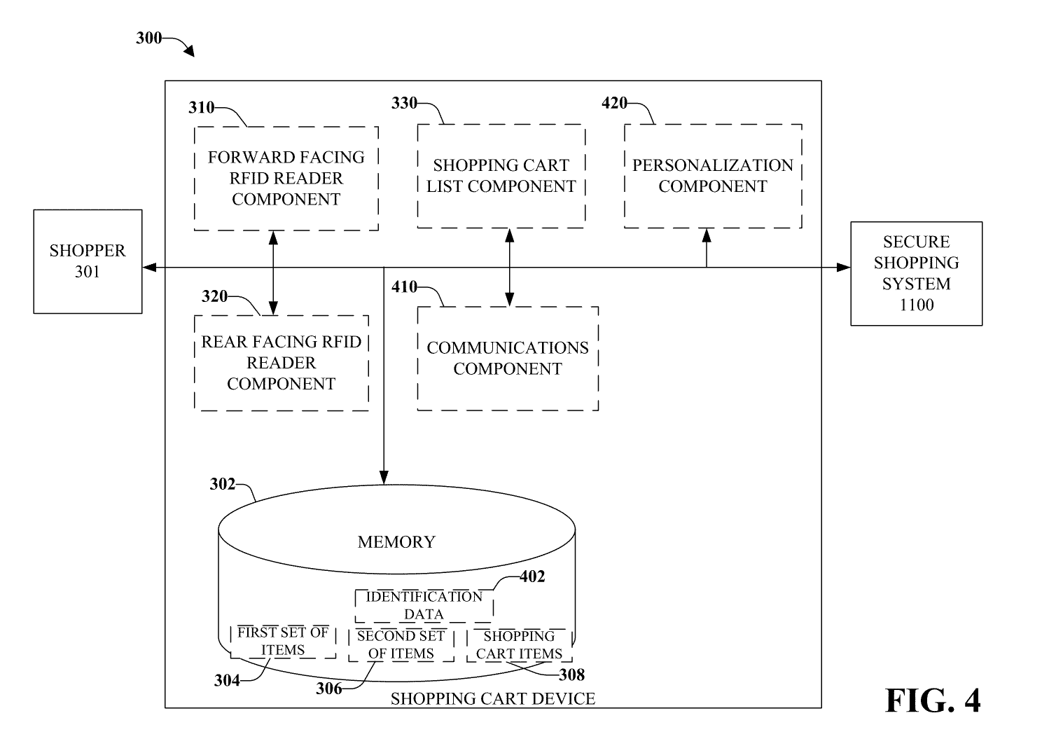

Referring now to FIG. 4, there is illustrated an example shopping cart device including communications and personalization components. Communications component 410 can send and receive data respectively to or from a secure shopping system 1100. Personalization component 420 can receive identification data based on user input received by the shopping cart device, wherein the identification data includes payment vehicle data. Payment vehicle data can include a debit card, a credit card, a routing number and account number, a store credit account, etc. Payment vehicle data can also include contact information necessary to validate other payment vehicle data such as an address, an ID, a phone number, a security code, a personal identification number, an email address, a security question answer, etc.

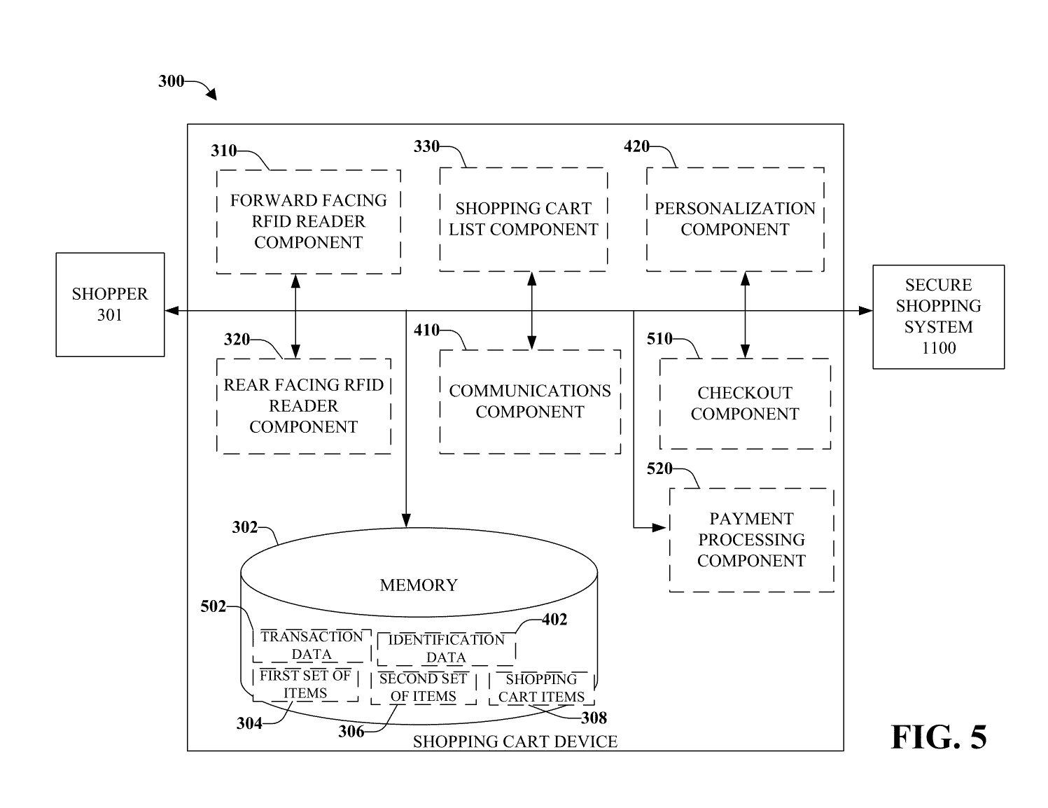

Referring now to FIG. 5, there is illustrated an example shopping cart device including checkout and payment processing components. Checkout component 510 can, in response to receiving a checkout request, process the set of shopping cart list items to generate transaction data and send the transaction data to the secure shopping system. It can be appreciated that by generating transaction data, it can be more easily determined which items are eventually paid for, transaction data, and which items the customer is leaving the store with, the set of shopping cart items.

Payment processing component 520 can present a transaction summary representing the transaction data to the user and requests a transaction authorization from the user. For example, the customer can input any information, e.g., signature, security code, pin number, security question answer, etc. needed to validate the transaction with the customer's bank.

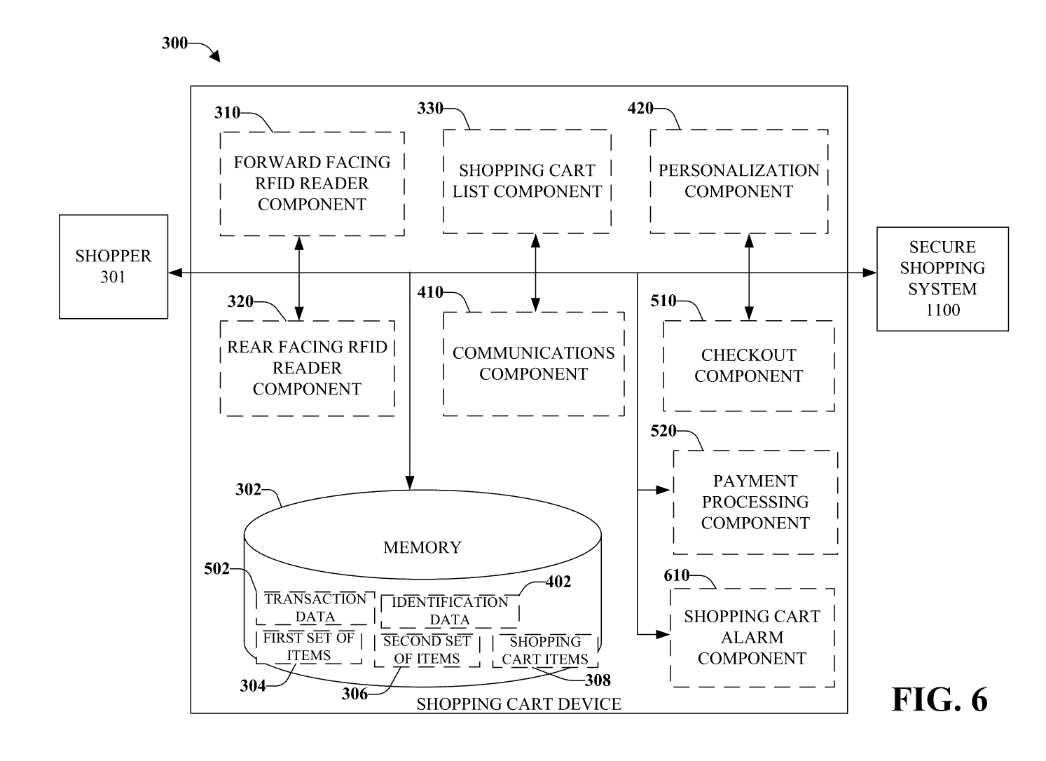

Referring now to FIG. 6, there is illustrated an example shopping cart device including a shopping cart alarm component. Shopping cart alarm component 610 can trigger an alarm based on the transaction data, the first set of items, and the second set of items. For example, shopping cart alarm component can determine what items are in the cart, e.g., items that are on both the first set of items and the second set of items. In another example, shopping cart alarm component can determine what items are on the person of a shopper near the cart, e.g., an item on either the first set of items or the second set of items but not on both. The items in the cart and the items on the person of the shopper, together, can be compared to the transaction data. For example, if the transaction data indicates not all the items in the cart and on the shopper have been paid for, an alarm can be triggered.

In one implementation, the shopping cart alarm component 610 can trigger the alarm further based on a set of defined security locations. For example, defined security locations can be those locations near an exit. Thus, shopping cart alarm component won't trigger an alarm outside the defined security location, e.g., anywhere within the store where the customer is most likely shopping and not trying to exit the store without paying for merchandise. It can be appreciated that a location RFID tag can be placed near the security locations whereupon either forward facing RFID reader component 310 or rear facing RFID reader component 320 reads the location RFID tag, shopping cart alarm component 610 is then allowed to trigger an alarm.

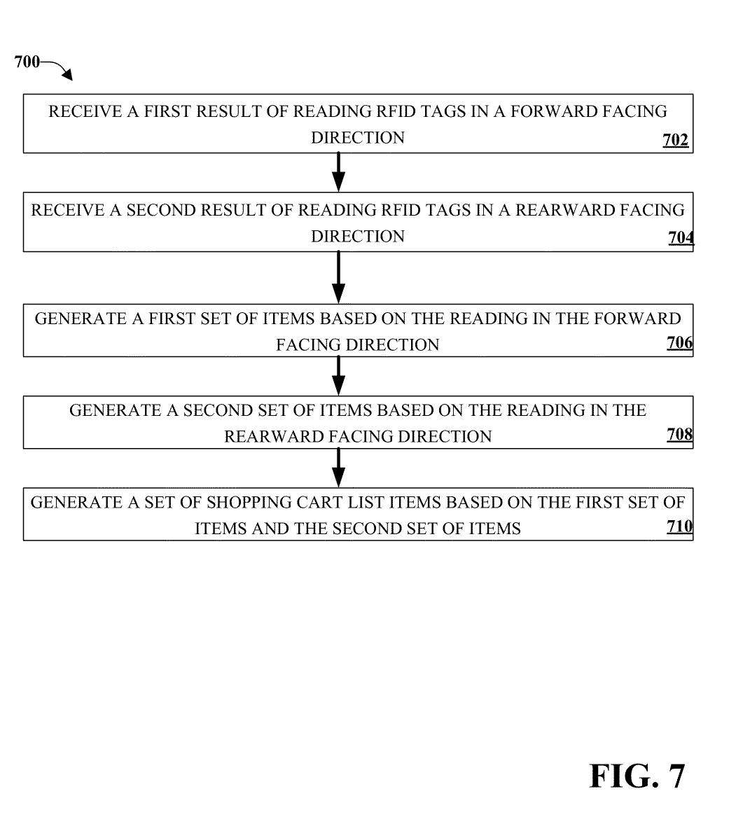

FIGS. 7-10 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIG. 7, there is illustrated an example flow diagram method for fast checkout using smart carts. At 702, a first result of reading RFID tags in a forward direction can be received. At 704, a second result of reading RFID tags in a rearward facing direction can be received. At 706, a first set of items can be generated based on the reading in the forward facing direction. At 708, a second set of items can be generated based on the reading in the rearward facing direction. At 710, a set of shopping cart list items can be generated based on the first set of items and the second set of items.

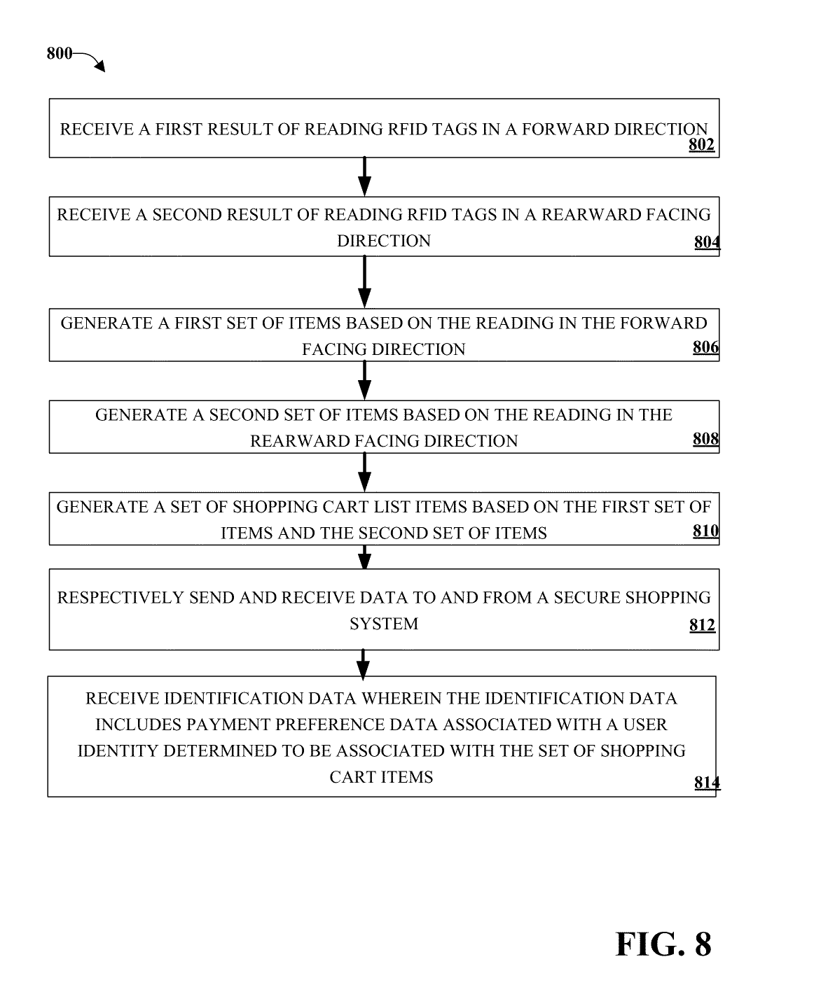

Referring now to FIG. 8, there is illustrated an example flow diagram method for fast checkout using smart carts including exchanging data with a secure shopping system. At 802, a first result of reading RFID tags in a forward direction can be received. At 804, a second result of reading RFID tags in a rearward facing direction can be received. At 806, a first set of items can be generated based on the reading in the forward facing direction. At 808, a second set of items can be generated based on the reading in the rearward facing direction. At 810, a set of shopping cart list items can be generated based on the first set of items and the second set of items. At 812, data can be sent and received respectively to and from a secure shopping system. At 814, identification data can be received wherein the identification data includes payment preference data associated with a user identity determined to be associated with the set of shopping cart list items.

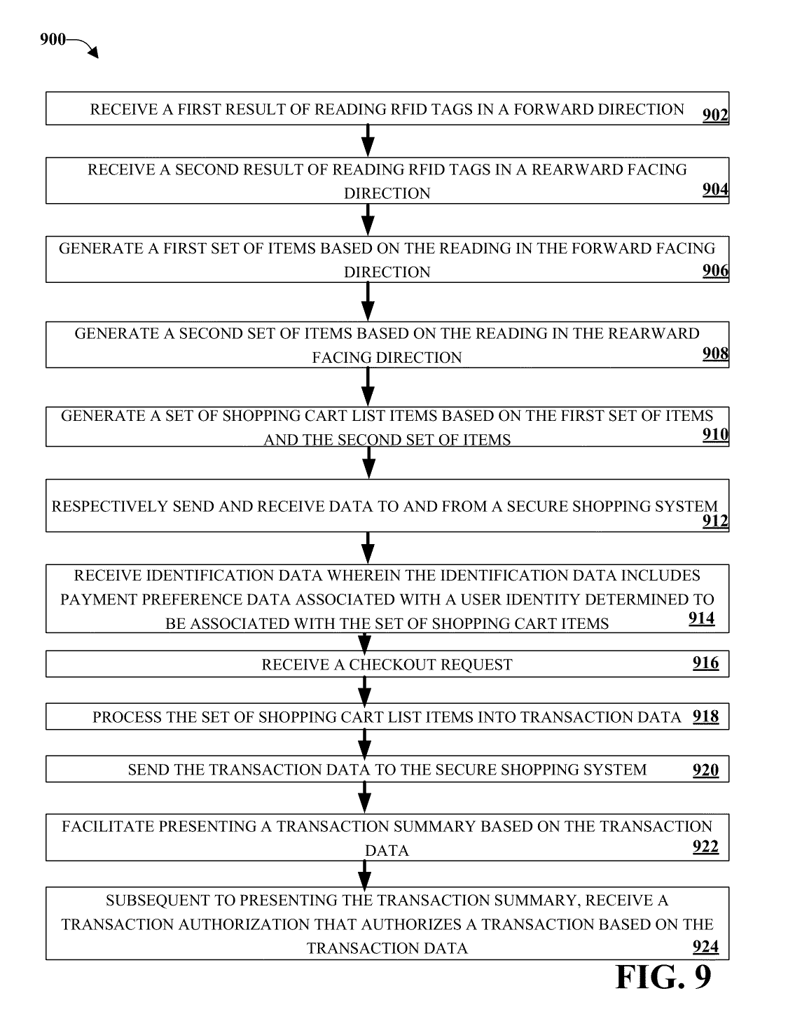

Referring now to FIG. 9, there is illustrated an example flow diagram method for fast checkout using smart carts including transacting a transaction. At 902, a first result of reading RFID tags in a forward direction can be received. At 904, a second result of reading RFID tags in a rearward facing direction can be received. At 906, a first set of items can be generated based on the reading in the forward facing direction. At 908, a second set of items can be generated based on the reading in the rearward facing direction. At 910, a set of shopping cart list items can be generated based on the first set of items and the second set of items. At 912, data can be sent and received respectively to and from a secure shopping system. At 914, identification data can be received wherein the identification data includes payment preference data associated with a user identity determined to be associated with the set of shopping cart list items.

At 916, a checkout request can be received. At 918, the set of shopping cart list items can be processed into transaction data. At 920, the transaction data can be sent to the secure shopping system. At 922, the method provides for facilitating presenting a transaction summary based on the transaction data. At 924, subsequent to presenting the transaction summary, a transaction authorization that authorizes a transaction based on the transaction data can be received.

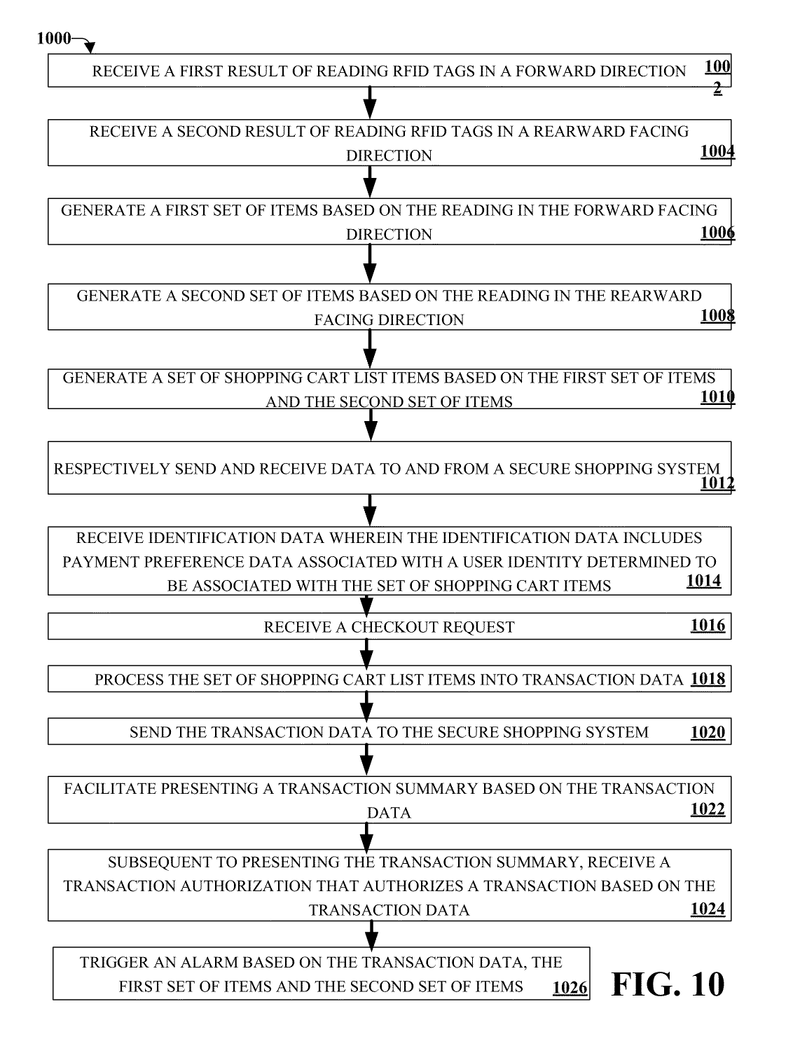

Referring now to FIG. 10, there is illustrated an example flow diagram method for fast checkout using smart carts including triggering an alarm. At 1002, a first result of reading RFID tags in a forward direction can be received. At 1004, a second result of reading RFID tags in a rearward facing direction can be received. At 1006, a first set of items can be generated based on the reading in the forward facing direction. At 1008, a second set of items can be generated based on the reading in the rearward facing direction. At 1010, a set of shopping cart list items can be generated based on the first set of items and the second set of items. At 1012, data can be sent and received respectively to and from a secure shopping system. At 1014, identification data can be received wherein the identification data includes payment preference data associated with a user identity determined to be associated with the set of shopping cart list items.

At 1016, a checkout request can be received. At 1018, the set of shopping cart list items can be processed into transaction data. At 1020, the transaction data can be sent to the secure shopping system. At 1022, the method provides for facilitating presenting a transaction summary based on the transaction data. At 1024, subsequent to presenting the transaction summary, a transaction authorization that authorizes a transaction based on the transaction data can be received. At 1026, an alarm can be triggered based on transaction data, the first set of items, and the second set of items.

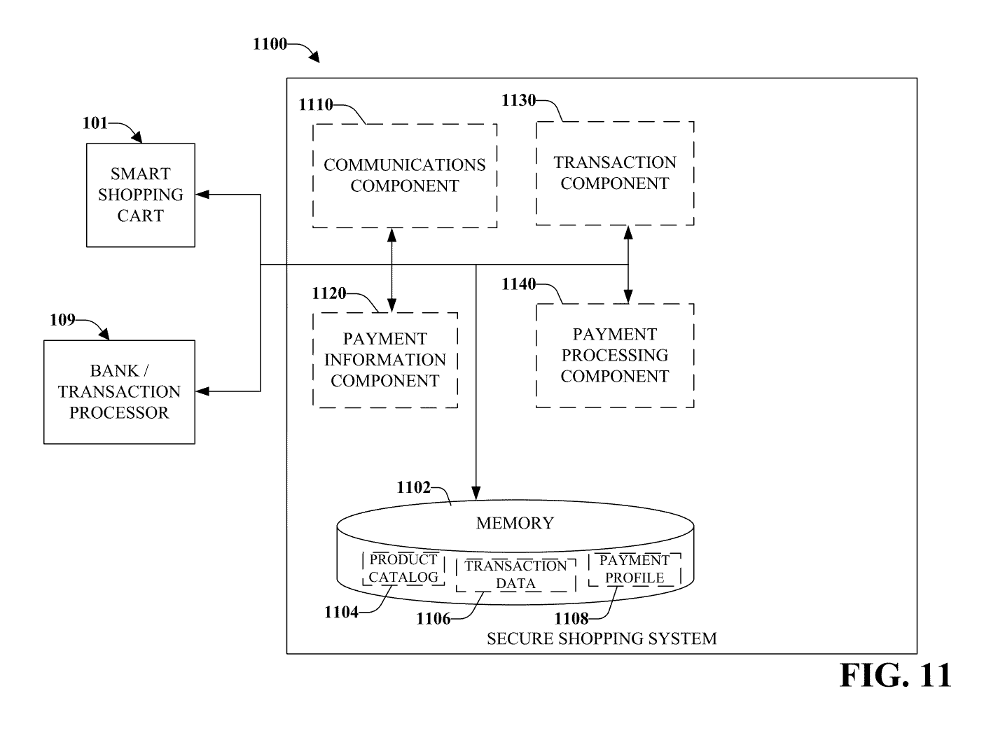

Referring now to FIG. 11, there is illustrated an example secure shopping system. Secure shopping system 1100 can contain a communications component 1110, a payment information component 1120, a transaction component 1130, a payment processing component 1140, and a memory 1102, that share a common bus. Memory 1102 can house a product catalog 1104, transaction data 1106, and payment profiles 1108 for use by other components. Communications component 1110 can be configured to send or receive data respectively to or from a shopping cart device 101.

Payment information component 1120 can receive a payment profile from the shopping cart device, wherein the payment profile includes at least a payment account. Payment account can include at least one of a debit card, a credit card, a routing number and account number associated with a checking account, or a store credit account. In one implementation, payment information component can further receive contact information as a part of the payment profile. In another implementation, payment processing component 1120 further can send a receipt associated with at least one of the transaction or the modified transaction to the contact information.

Transaction component 1130 can receive transaction data representing transaction items from the shopping cart device wherein the transaction data includes radio frequency identification (“RFID”) tag data associated with the transaction items. For example, the RFID tag data can include associated RFID tags that are associated with items in the transaction list. Payment processing component 1140 can process a transaction based on the transaction data and the payment profile. In one implementation, payment processing component 1140 can process the transaction independent of the location of the shopping cart device.

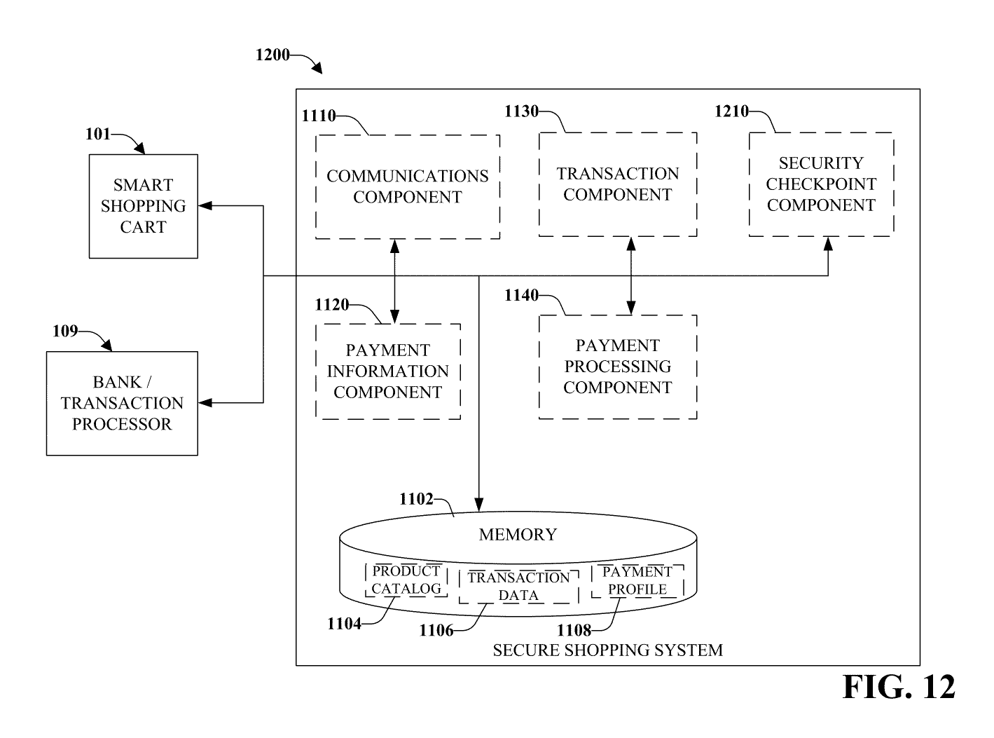

Referring now to FIG. 12, there is illustrated an example secure shopping system including a security checkout component. Security checkpoint component 1210 can generate an exit list based on scanning a security checkpoint for RFID tags, wherein the exit list represents a set of items determined to be present at the security checkpoint. It can be appreciated that security checkpoint component 1210 can be work in conjunction with a shopping cart generating an exit list. For example, if a shopping cart was tampered with, or if a shopping cart RFID reader does not read a product correctly, the exit list generated by security checkpoint component 1210 can be more accurate.

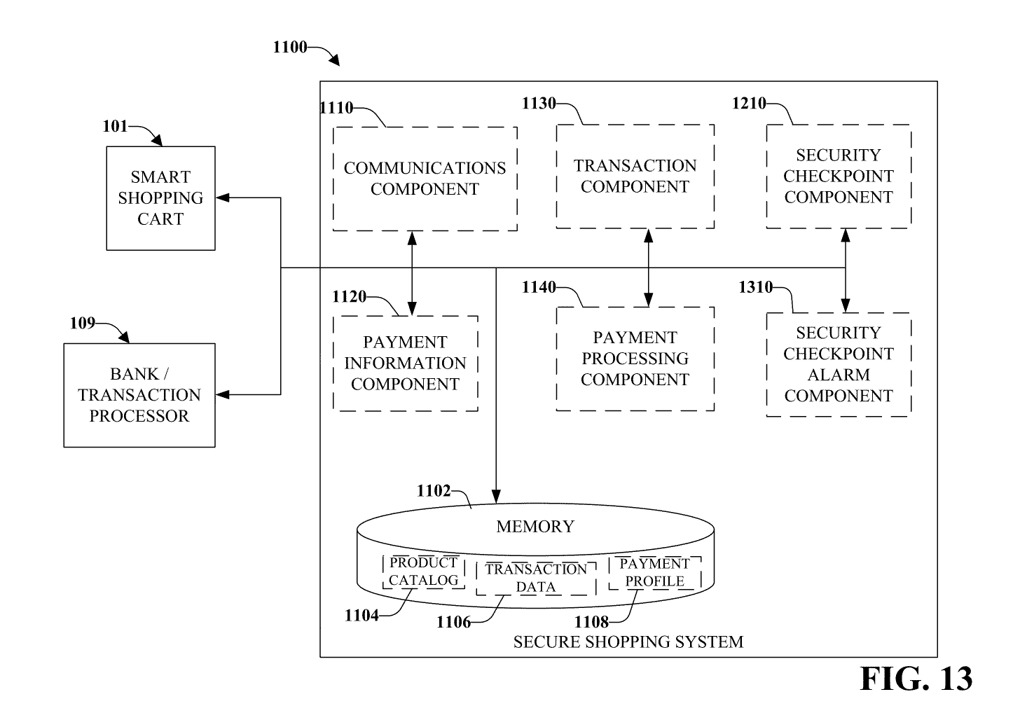

Referring now to FIG. 13, there is illustrated an example secure shopping system including a security checkpoint alarm component. Security checkpoint alarm component 1310 can trigger an alarm or a notification based on the exit list and the transaction data. It can be appreciated that this action can occur independently from the shopping cart setting off a separate alarm.

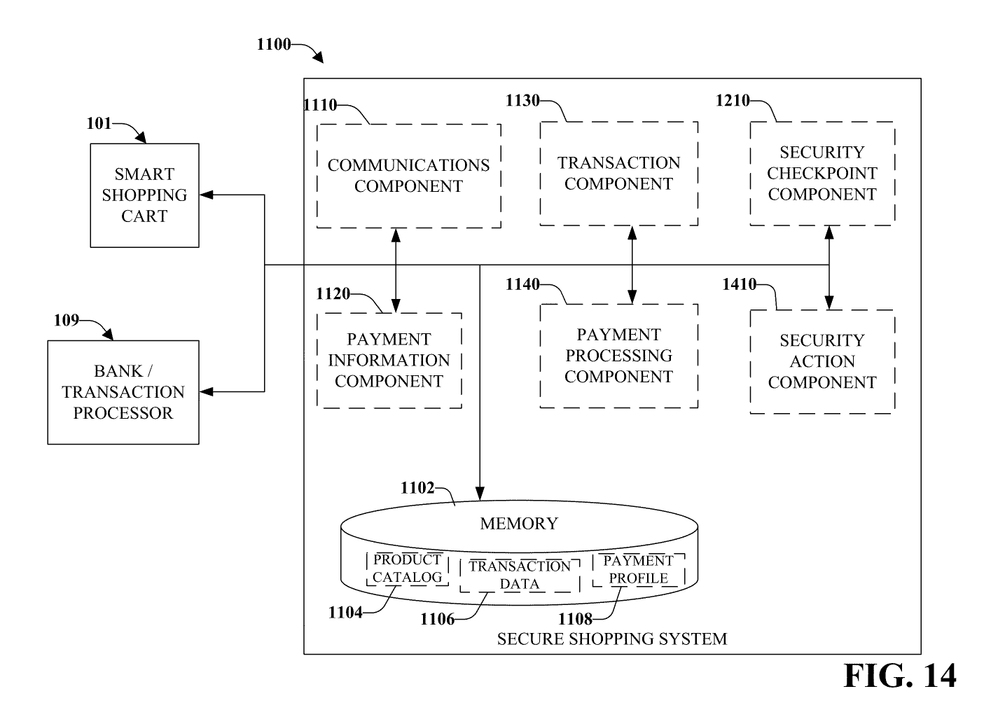

Referring now to FIG. 14, there is illustrated an example secure shopping system including a security action component. Security action component 1410 can modify the transaction based on a comparison of the set of items of the exit list and the transaction items. For example, the payment means can be charged for additional merchandise not previously paid for. Alternatively, the payment means can be credited for merchandise paid for but not exited the store with. In another implementation, the shopper can be given the option of how to proceed, by being presented with a modified transaction summary for example.

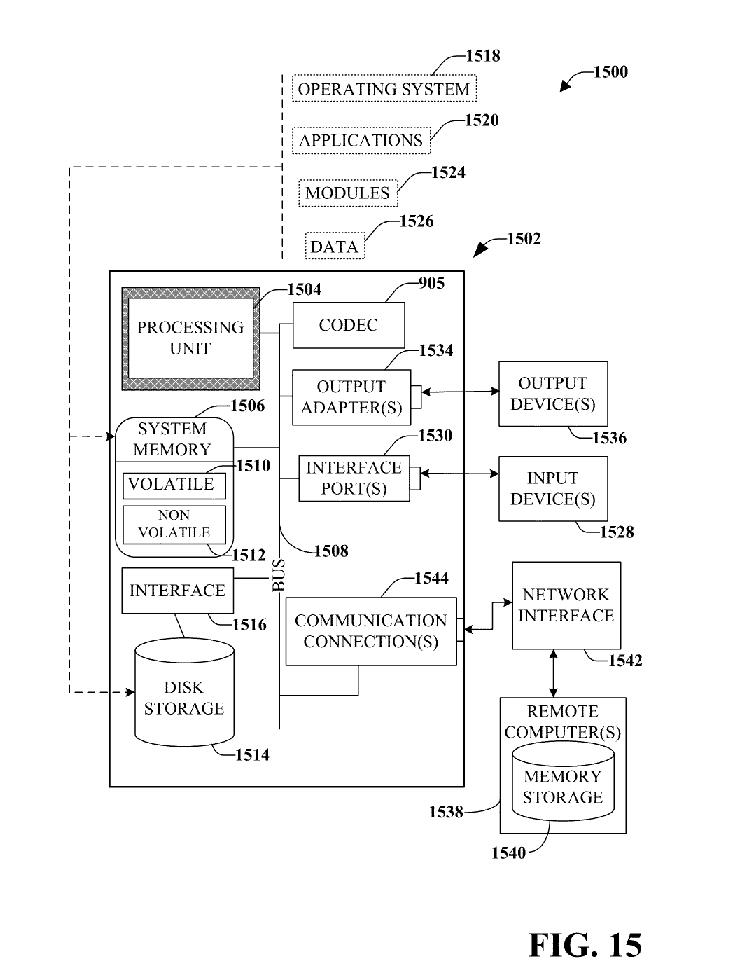

With reference to FIG. 15, a suitable environment 1500 for implementing various aspects of the claimed subject matter includes a computer 1502. The computer 1502 includes a processing unit 1504, a system memory 1506, a codec 1505, and a system bus 1508. The system bus 1508 couples system components including, but not limited to, the system memory 1506 to the processing unit 1504. The processing unit 1504 can be any of various available processors. Dual microprocessors and other multiprocessor architectures also can be employed as the processing unit 1504.

The system bus 1508 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1506 includes volatile memory 1510 and non-volatile memory 1512. The basic input/output system (BIOS), containing the basic routines to transfer information between elements within the computer 1502, such as during start-up, is stored in non-volatile memory 1512. By way of illustration, and not limitation, non-volatile memory 1512 can include read only memory (ROM), programmable ROM (PROM), electrically programmable ROM (EPROM), electrically erasable programmable ROM (EEPROM), or flash memory. Volatile memory 1510 includes random access memory (RAM), which acts as external cache memory. According to present aspects, the volatile memory may store the write operation retry logic (not shown in FIG. 15) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1502 may also include removable/non-removable, volatile/non-volatile computer storage media. FIG. 15 illustrates, for example, a disk storage 1514. Disk storage 1514 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1514 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1514 to the system bus 1508, a removable or non-removable interface is typically used, such as interface 1516.

It is to be appreciated that FIG. 15 describes software that acts as an intermediary between users and the basic computer resources described in the suitable operating environment 1500. Such software includes an operating system 1518. Operating system 1518, which can be stored on disk storage 1514, acts to control and allocate resources of the computer system 1502. Applications 1520 take advantage of the management of resources by operating system 1518 through program modules 1524, and program data 1526, such as the boot/shutdown transaction table and the like, stored either in system memory 1506 or on disk storage 1514. It is to be appreciated that the claimed subject matter can be implemented with various operating systems or combinations of operating systems.

A user enters commands or information into the computer 1502 through input device(s) 1528. Input devices 1528 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1504 through the system bus 1508 via interface port(s) 1530. Interface port(s) 1530 include, for example, a serial port, a parallel port, a game port, and a universal serial bus (USB). Output device(s) 1536 use some of the same type of ports as input device(s) 1528. Thus, for example, a USB port may be used to provide input to computer 1502, and to output information from computer 1502 to an output device 1536. Output adapter 1534 is provided to illustrate that there are some output devices 1536 like monitors, speakers, and printers, among other output devices 1536, which require special adapters. The output adapters 1534 include, by way of illustration and not limitation, video and sound cards that provide a means of connection between the output device 1536 and the system bus 1508. It should be noted that other devices and/or systems of devices provide both input and output capabilities such as remote computer(s) 1538.

Computer 1502 can operate in a networked environment using logical connections to one or more remote computers, such as remote computer(s) 1538. The remote computer(s) 1538 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1502. For purposes of brevity, only a memory storage device 1540 is illustrated with remote computer(s) 1538. Remote computer(s) 1538 is logically connected to computer 1502 through a network interface 1542 and then connected via communication connection(s) 1544. Network interface 1542 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1544 refers to the hardware/software employed to connect the network interface 1542 to the bus 1508. While communication connection 1544 is shown for illustrative clarity inside computer 1502, it can also be external to computer 1502. The hardware/software necessary for connection to the network interface 1542 includes, for exemplary purposes only, internal and external technologies such as, modems including regular telephone grade modems, cable modems and DSL modems, ISDN adapters, and wired and wireless Ethernet cards, hubs, and routers.

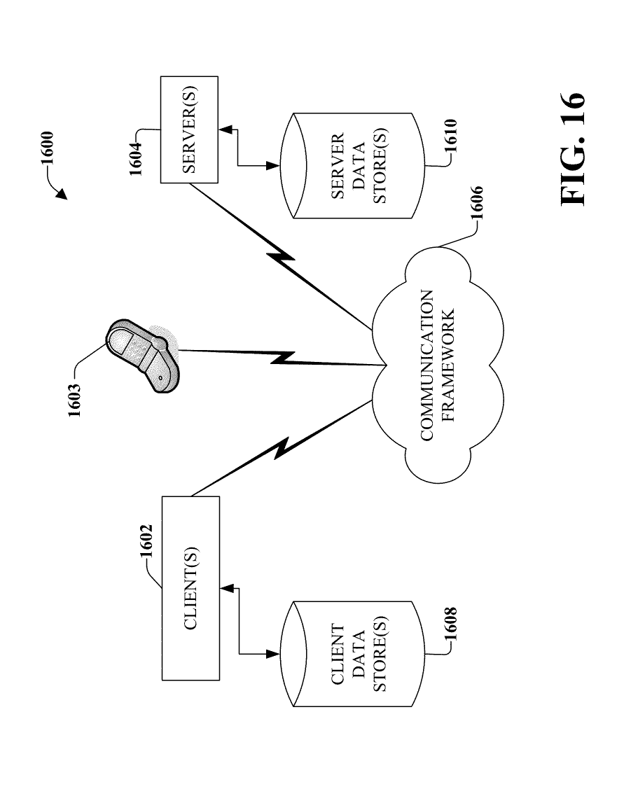

Referring now to FIG. 16, there is illustrated a schematic block diagram of a computing environment 1600 in accordance with the subject specification. The system 1600 includes one or more client(s) 1602, which can include an application or a system that accesses a service on the server 1604. The client(s) 1602 can be hardware and/or software (e.g., threads, processes, computing devices). The client(s) 1602 can house cookie(s) and/or associated contextual information by employing the specification, for example.

The system 1600 also includes one or more server(s) 1604. The server(s) 1604 can also be hardware or hardware in combination with software (e.g., threads, processes, computing devices). The servers 1604 can house threads to perform, for example, identifying morphological features, extracting meaning, auto generating FAQs, ranking, etc. One possible communication between a client 1602 and a server 1604 can be in the form of a data packet adapted to be transmitted between two or more computer processes where the data packet contains, for example, a certificate. The data packet can include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A shopping cart device, comprising:
a memory that stores computer executable components; and
a processor that facilitates execution of computer executable components stored within the memory, the computer executable components, comprising:
a forward facing radio frequency identification (“RFID”) reader component that reads a first set of RFID tags and generates a first set of items based on RFID information read from the first set of RFID tags;
a rear facing RFID reader component that reads a second set of RFID tags and generates a second set of items based on RFID information read from the second set of RFID tags; and
a shopping cart list component that adds and removes items to a set of shopping cart items based on updates received from the forward facing RFID reader component and the rear facing RFID reader component regarding the first set of items and the second sets of items.

2. The shopping cart device of claim 1, wherein the front facing RFID reader component and the rear facing RFID reader component are arranged to read RFID tags from opposite directions.

3. The shopping cart device of claim 2, wherein the front facing RFID reader component and the rear facing RFID reader component read RFID tags are mechanically coupled to the shopping cart device.

4. The shopping cart device of claim 1, wherein the computer executable components further comprise:
a communications component that sends and receives data respectively to or from a secure shopping system; and
a personalization component that receives identification data based on user input received by the shopping cart device, wherein the identification data includes payment vehicle data.

5. The shopping cart device of claim 4, wherein the computer executable components further comprise:
a checkout component that, in response to receiving a checkout request, processes the set of shopping cart list items to generate transaction data and sends the transaction data to the secure shopping system; and
a payment processing component that presents a transaction summary representing the transaction data to the user and requests a transaction authorization from the user.

6. The shopping cart device of claim 5, wherein the computer executable components further comprise:
a shopping cart alarm component that triggers an alarm based on the transaction data, the first set of items, and the second set of items.

7. The shopping cart device of claim 6, wherein the shopping cart alarm component triggers the alarm based at least partly on a set of defined security locations.

8. A secure shopping system, comprising:
a memory that stores computer executable components; and
a processor, communicatively coupled to the memory, that facilitates execution of computer executable components, the computer executable components comprising:
a communications component that is configured to send or receive data respectively to or from a shopping cart device;
a payment information component that receives a payment profile from the shopping cart device, wherein the payment profile includes at least a payment account;
a transaction component that receives transaction data representing transaction items from the shopping cart device wherein the transaction data includes radio frequency identification (“RFID”) tag data associated with the transaction items; and
a payment processing component that processes a transaction based on the transaction data and the payment profile.

9. The secure shopping system of claim 8, wherein the computer executable components further comprise:
a security checkpoint component that generates an exit list based on scanning a security checkpoint for RFID tags, wherein the exit list represents a set of items determined to be present at the security checkpoint.

10. The secure shopping system of claim 9, wherein the computer executable components further comprise:
a security checkpoint alarm component that triggers an alarm or a notification based on the exit list and the transaction data.

11. The secure shopping system of claim 9, wherein the computer executable components further comprise:
a security action component that modifies the transaction data based on a comparison of the set of items of the exit list and the transaction items.

12. The secure shopping system of claim 8, wherein the payment account is at least one of a debit card, a credit card, a routing number, an account number, or a store credit account.

13. The secure shopping system of claim 8, wherein the payment information component further receives contact information as a part of the payment profile.

14. The secure shopping system of claim 13, wherein the payment processing component further sends a receipt associated with the transaction data to the contact information.

15. The secure shopping system of claim 10, wherein the security checkpoint generates the exit list based on at least one of long range RFID scanning, or short range RFID scanning.

16. The secure shopping system of claim 8, wherein the payment processing component processes the transaction independent of a location of the shopping cart device.

17. A method, comprising:
receiving, by a system including a processor, a first result of reading radio frequency identification (“RFID”) tags in a forward facing direction;
receiving, by the system, a second result of reading RFID tags in a rearward facing direction;
generating a first set of items based on the reading in the forward facing direction;
generating a second set of items based on the reading in the rearward facing direction; and
generating a set of shopping cart list items based on the first set of items and the second set of items.

18. The method of claim 17, wherein the forward facing direction and the rearward facing direction are opposite directions.

19. The method of claim 18, wherein the first set of items and the second set of items include a same item.

20. The method of claim 17, further comprising:
respectively sending and receiving data to and from a secure shopping system; and
receiving identification data wherein the identification data includes payment preference data associated with a user identity determined to be associated with the set of shopping cart list items.

21. The method of claim 20, further comprising:
receiving a checkout request;
processing the set of shopping cart list items into transaction data;
sending the transaction data to the secure shopping system;
facilitating presenting a transaction summary based on the transaction data; and
subsequent to presenting the transaction summary, receiving a transaction authorization that authorizes a transaction based on the transaction data.

22. The method of claim 21, further comprising:
triggering an alarm based on the transaction data, the first set of items, and the second set of items.
